(19) United States
(12) Patent Application Publication
(10) Pub. No.: US 2020/0406577 A1
(43) Pub. Date: Dec. 31, 2020

(54) METHOD AND DEVICE FOR MANUFACTURING HONEYCOMB CORE BY DOMED BONDING LAYER

(71) Applicant: TEC CO., LTD., Utsunomiya-City, Tochigi (JP)

(72) Inventor: Takeshi SUGITA, Tochigi (JP)

(73) Assignee: TEC Co., Ltd., Utsunomiya-City, Tochigi (JP)

(21) Appl. No.: 16/481,674

(22) PCT Filed: May 8, 2018
(86) PCT No.: PCT/JP2018/017848

§ 371 Date: Jul. 29, 2019

(30) Foreign Application Priority Data
Feb. 22, 2018 (JP) 2018-029543

(51) Int. Cl. B32B 3/12; B32B 7/12; B29C 65/26; B32B 37/06

(52) U.S. Cl. CPC B32B 3/12; B32B 7/12; B32B 2037/1223; B32B 37/06; B29C 65/26

(57) ABSTRACT

In a method for manufacturing a honeycomb core by a domed bonding layer, a bonding sheet is, upon bonding of each cell, heated with hot air to form a uniform bonding layer on an end surface of each honeycomb cell, thereby providing a lightweight honeycomb core having stable strength. In the method for manufacturing the honeycomb core, a technique including the doming step of pumping, when bonding molding is performed for a core in which multiple ribs are connected to form an assembly of cells by means of a flat thermally-weldable bonding sheet laid on an upper surface of the core, upward hot air upwardly into the cells to form a dome-shaped bonding layer at the bonding sheet on an upper surface of each cell, the rupturing step of pumping downward hot air from above to the vicinity of the top of the dome-shaped bonding layer to rupture the bonding layer, and the thermal welding step of forming a uniform bonding layer on upper edge portions of the cells by means of meltability and surface tension.

### TECHNICAL FIELD

The present invention relates to a honeycomb member. Specifically, the present invention relates to the method for manufacturing a lightweight honeycomb core having stable strength in such a manner a bonding sheet is first heated with hot air to form a uniform bonding layer on an end surface of each honeycomb cell.

### BACKGROUND ART

With recent development of an aero technology industry, for a technique regarding a material such as a complex material using carbon fibers, lighter and stronger materials have been provided. These new materials have been also utilized for other industries. Specifically, a manufacturing technique regarding a honeycomb member has been impressively developed. Currently, these materials are applied not only to an air industry but also to vehicle bodies of trains and automobiles or floor materials of buildings.

However, when such a honeycomb member is utilized in many other fields than aircrafts, there are the following problems as disadvantages of the honeycomb member. That is, it is difficult to couple the honeycomb members. Moreover, there is also a problem that the honeycomb member has strong directionality in terms of strength, and as a result, there is a problem that it is not easy to use the honeycomb member. Further, there is also a problem that a burden is great in terms of cost.

For these reasons, various techniques have been typically proposed. Specifically, a technique relating to a honeycomb core as the title of the invention has been disclosed as a well-known technique, for example (see Patent Literature 1). In this technique, a fold crossing a cell arrangement direction is formed at a cell wall of each cell forming the honeycomb core. Thus, expansion/contraction deformation is allowed in each cell, and balance stress generated due to bending can be dispersed to the entirety of a cell group. Thus, various bending such as secondary bending and tertiary bending can be provided without buckling the cell in response to bending with a small curvature radius. However, in the invention described in Patent Literature 1, the fold crossing the cell arrangement direction needs to be formed at each cell wall for allowing bending at the honeycomb core including a cell assembly. Moreover, a single cell needs to be bent in a trapezoidal shape. On these points, this technique is different from the present invention in the technique of solving the problems.

Moreover, a technique relating to a honeycomb core and a honeycomb core manufacturing method as the tile of the invention is disclosed as a well-known technique (see Patent Literature 2). In this technique, the honeycomb core includes a planar assembly of hollow columnar cells divided by cell walls, each cell wall between joint spots does not form a flat surface in a linear sectional shape, and at least one bent portion is present to form a broken-line sectional shape. Moreover, such a honeycomb core adds, to a typical manufacturing method by an extension method, temporal joining with a second joint member having poorer joint force than that of a typical first joint member, and the bent portion remains at the cell wall by means of plastic deformation of a mark formed due to separation of a temporarily-joined portion during extension. Thus, in the honeycomb core, internal and external contraction deformation or expansion deformation are smoothly performed upon curved surface molding. However, in the invention described in Patent Literature 2, the state of the cell assembly forming the honeycomb core is partially joined to form a curved surface. In such a configuration, stiffness between the cell walls becomes interference, and it is difficult to form the curved surface. Further, the shape of each cell is a tapered shape, and therefore, a proper tapered shape according to the curvature of the formed curved surface needs to be formed. There is still a challenge to ensure stiffness.

Further, a technique relating to the method for filling a honeycomb core with resin as the title of the invention is disclosed as a well-known technique (see Patent Literature 3). This technique includes the step of arranging a skin layer larger than a honeycomb core resin charging region in the resin charging region, the step of covering an upper surface of the skin layer with a release film and vent fabric to perform vacuuming, pressurization, and heating to bond the skin layer to the honeycomb core member, the step of cutting a core and the skin layer in the resin charging region from the honeycomb core member, the step of bonding a tape to one surface of the core in the cutoff region to charge and harden the resin with the tape bonded side being on a lower side, and the step of separating and removing the tape and the skin layer after the resin has been hardened. However, in the invention described in Patent Literature 3, vacuuming is used as an uniformization technique. Thus, a large autoclave is necessary. As a result, there is a problem that a manufacturable size is limited. Note that in the present invention, manufacturing can be performed by heating and pressurization under atmospheric pressure. Thus, the size of the honeycomb core member to be manufactured is not limited.

In addition, a technique relating to a honeycomb core manufacturing method using a flexible domed bonding layer and a flexible honeycomb core as the title of the invention is disclosed as a well-known technique (see Patent Literature 4). In this technique, resin is, for a foil member made of fiber-reinforced plastic, first heated and pressurized by a heat corrugated roller to form a corrugated plate in a triangular wave shape. Next, the corrugated plates are stacked, bonded, and extended such that each cell wall is bent in the middle. As a result, the flexible honeycomb core configured such that each cell is in a substantially rounded raised shape is manufactured. The invention described in Patent Literature 4 is common to the present invention in that flexibility is provided to a honeycomb core member. However, a molding step is performed by a general gear structure called the heat corrugated roller. On this point, this technique is greatly different from the present invention in terms of a technical solution to a problem.

### CITATION LIST

### Patent Literature

PATENT LITERATURE 1: JP-A-6-198364
PATENT LITERATURE 2: JP-A-9-290470
PATENT LITERATURE 3: JP-A-8-025533
PATENT LITERATURE 4: JP-A-6-218856

### SUMMARY OF THE INVENTION

### Problems to be Solved by the Invention

The present invention is intended to provide a lightweight honeycomb core having stable strength in such a manner that in a honeycomb core manufacturing method using a domed bonding layer, a bonding sheet is heated with hot air upon bonding of each cell to form a uniform bonding layer on an end surface of each honeycomb cell.

### Solution to the Problems

The present invention employs a method for manufacturing a honeycomb core by a domed bonding layer, including: a doming step of pumping, when bonding molding is performed for a core including multiple connected ribs forming an assembly of cells by means of a flat thermally-weldable bonding sheet laid on an upper surface of the core, upward hot air upwardly into the cells to form a dome-shaped bonding layer at the bonding sheet on an upper surface of each cell; a rupturing step of pumping downward hot air from above to a vicinity of a top of the dome-shaped bonding layer to rupture the bonding layer; and a thermal welding step of forming a uniform bonding layer on upper edge portions of the cells by means of meltability and surface tension of the bonding sheet.

Further, the present invention may employ the method further including a re-heating step of re-heating the bonding layer after the doming step to the thermal welding step.

Further, the present invention may employ the method in which the upward hot air is toward substantially centers of the cells, and the downward hot air is in parallel with a line passing through the top.

Further, the present invention may employ the method in which at the doming step, the upward hot air to be pumped is adjusted according to heights of the cells to form the dome-shaped bonding layer and provide a curved surface to the honeycomb core.

Further, the present invention may employ a device for manufacturing a honeycomb core by a domed bonding layer, including: a bottom-side hot air device configured to pump, when bonding molding is performed for a core including multiple connected ribs forming an assembly of cells by means of a flat thermally-weldable bonding sheet laid on an upper surface of the core, upward hot air into the cells upwardly through a nozzle plate to form a dome-shaped bonding layer at the bonding sheet on an upper surface of each cell; and an upper-side hot air device configured to pump downward hot air from above to a vicinity of a top of the dome-shaped bonding layer to rupture the bonding layer. A uniform bonding layer is formed on upper edge portions of the cells by means of meltability and surface tension of the bonding sheet.

Further, the present invention may employ a configuration in which bottom-side nozzles provided at the nozzle plate are arranged in two or more lines to re-heat the bonding layer.

Further, the present invention may employ a configuration in which the upward hot air is toward substantially centers of the cells, and the downward hot air is in parallel with a line passing through the top.

Further, the present invention may employ a configuration in which the upward hot air to be pumped to the bonding sheet by the bottom-side hot air device is adjusted according to heights of the cells.

### Effects of the Invention

According to the honeycomb core manufacturing method and device using the domed bonding layer according to the present invention, an excellent effect that bonding resin for binding each cell can be uniformly applied to each cell without waste when a honeycomb core member is formed is provided.

Moreover, according to the honeycomb core manufacturing method and device using the domed bonding layer according to the present invention, an excellent effect that the honeycomb core can ensure stable strength due to bonding of the honeycomb core member with uniform resin is provided.

Further, according to the honeycomb core manufacturing method and device using the domed bonding layer according to the present invention, an excellent effect that in a case where the honeycomb core member needs to be used for a curved surface, a curved surface can be freely formed and the honeycomb core can be used for various use applications accordingly is provided.

In addition, according to the honeycomb core manufacturing method and device using the domed bonding layer according to the present invention, an excellent effect that bonding between a face plate and the honeycomb core is performed in a state in which the bonding layer is raised on upper and lower edge portions of each cell by surface tension and the bonding layer can be accordingly utilized as an adhesive for the face plate without the need for applying an adhesive again is provided.

Moreover, according to the honeycomb core manufacturing method and device using the domed bonding layer according to the present invention, an excellent effect that a heating method using gas as hot air is used for heating of each cell and completion of heating within a short period of time and reduction of influence of heat on the core can be achieved accordingly is provided.

### BRIEF DESCRIPTION OF THE DRAWINGS

FIG. 1 is a flowchart of the steps of a honeycomb core manufacturing method using a domed bonding layer according to the present invention.

FIG. 2 is a view for describing heating states in the honeycomb core manufacturing method using the domed bonding layer according to the present invention.

FIG. 3 is a view for describing heating states in the honeycomb core manufacturing method using the domed bonding layer according to the present invention.

FIG. 4 is a view for describing a hot air pumping state in a honeycomb core manufacturing method using the domed bonding layer according to the present invention.

FIG. 5 is a view for describing an embodiment in which a face plate is bonded to a honeycomb core according to the present invention.

FIG. 6 is a view for describing an arrangement state regarding hot air to be pumped to each cell in the honeycomb core manufacturing device using the domed bonding layer according to the present invention.

FIG. 7 is a view for describing a configuration in which a bonding layer is re-heated in the honeycomb core manufacturing device using the domed bonding layer according to the present invention.

FIG. 8 is a view for describing the method for processing a curved surface in the honeycomb core manufacturing device using the domed bonding layer according to the present invention.

### DESCRIPTION OF THE EMBODIMENTS

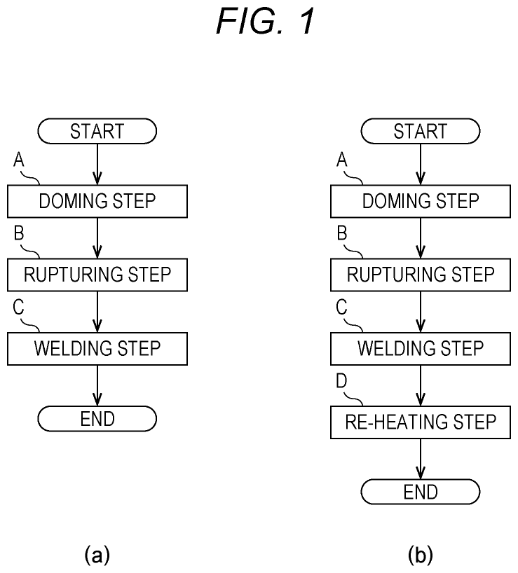

A biggest feature of a honeycomb core manufacturing method 1 using a domed bonding layer according to the present invention is that multiple cells 11 are uniformly bonded to form a honeycomb core. Hereinafter, the honeycomb core manufacturing method 1 using the domed bonding layer according to the present invention will be described with reference to FIGS. 1 to 3. Note that the present invention is not intended to exclude a normal honeycomb panel manufacturing method. The step of molding a face plate 70 and the step of molding a core 13 may be provided before and after such a flow. Alternatively, such a honeycomb core manufacturing flow can be utilized as a manufacturing step flow used as part of the entire step of manufacturing a honeycomb core 10, the entire step including, e.g., a bonding step having a combination of the above-described molding steps.

FIG. 1 is a flowchart of the steps of the honeycomb core manufacturing method 1 using the domed bonding layer according to the present invention. FIG. 1(a) illustrates a basic flow of the honeycomb core manufacturing method 1 using the domed bonding layer according to the present invention. On the other hand, FIG. 1(b) illustrates another flow in which a re-heating step D is added after a thermal welding step C.

The honeycomb core manufacturing method 1 using the domed bonding layer according to the present invention includes a doming step A, a rupturing step B, and the thermal welding step C. Honeycomb member manufacturing includes, for example, the step of bonding the face plates 70 to both surfaces of the honeycomb core 10. The present invention is characterized in the step of bonding the core 13 as a core member and an adhesive. Thus, description of other steps will be omitted.

At the doming step A as an initial step, a bonding sheet 20 is laid without clearances on one or both surfaces of the core 13 configured such that the multiple cells 11 are connected to each other. The core 13 on which the bonding sheet 20 is laid is heated, and accordingly, the bonding sheet 20 is melted. Thereafter, ribs 12 of upper portions of the cells 11 are bonded to each other. At such a doming step A, upward hot air 41 is upwardly pumped using a bottom-side hot air device 40. The bonding sheet 20 heated as described above is softened, and as a result, a dome-shaped bonding layer 22 is molded on an upper surface of the cell 11. Note that at this point, downward hot air 51 is simultaneously pumped by an upper-side hot air device 50. At this point, the upward hot air 41 is pumped with a higher pressure than that for the downward hot air 51. Thus, the dome-shaped bonding layer 22 formed on each cell 11 is thinned and is in an easily-rupturable state.

At the rupturing step B, the downward hot air 51 is pumped to the vicinity of the top 23 of the dome-shaped bonding layer 22 from above by the upper-side hot air device 50. Accordingly, the vicinity of the top 23 of the dome-shaped bonding layer 22 is ruptured. Then, the ruptured dome-shaped bonding layer 22 is, due to surface tension, equally dispersed with the same amount onto the ribs 12 formed on the same side at the upper surface of each cell 11.

At the thermal welding step C, the dome-shaped bonding layer 22 dispersed onto the upper surface of each cell 11 is thermally welded to the cells 11 adjacent to each rib 12 due to surface tension and the force of gravity. Thus, an entirely-uniform bonding layer 30 is formed.

At the re-heating step D, the upward hot air 41 is pumped again by the bottom-side hot air device 40. This reliably ruptures the dome-shaped bonding layer 22. Moreover, the bonding layer 30 becomes more uniform. Note that in the honeycomb core manufacturing method 1 using the domed bonding layer according to the present invention, the re-heating step D is not necessarily required. For the uniform bonding layer 30, such a re-heating step D is more preferably provided.

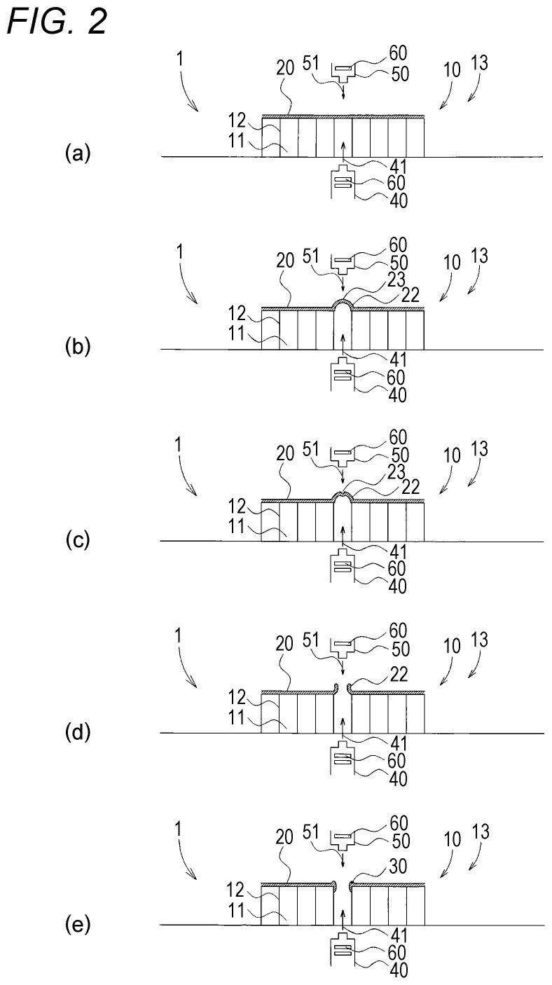

FIG. 2 is a view for describing heating states in the honeycomb core manufacturing method 1 using the domed bonding layer according to the present invention. FIG. 2(a) illustrates a state in which the bonding sheet 20 is laid on an upper surface of the core 13. FIG. 2(b) illustrates a state in which the upward hot air 41 is, at the doming step A, pumped to the bonding sheet 20 and the dome-shaped bonding layer 22 is formed accordingly. FIG. 2(c) illustrates a state in which the downward hot air 51 is, at the rupturing step B, pumped and the vicinity of the top 23 of the dome-shaped bonding layer 22 starts rupturing. FIG. 2(d) illustrates a state in which the ruptured dome-shaped bonding layer 22 is, at the rupturing step B, dispersed to an opening edge portion of each cell 11. FIG. 2(e) illustrates a state in which the bonding layer 30 is formed at the thermal welding step C. In this case, the melted adhesive is uniformly distributed to an upper side of each rib 12 by surface tension.

As illustrated in FIG. 2(a), when the bonding sheet 20 is laid on the upper surface of the core 13, the bonding sheet 20 can be laid without clearances due to flexibility of the bonding sheet 20. Even in a case where a slight clearance is formed, the bonding sheet 20 is softened by heating, and closely contacts the surface of the core 13. Thus, a special device such as a pressurization device or a vacuuming device is not necessarily used. Note that of vertical thin arrows illustrated in the figure, upward arrows indicate the upward hot air 41. Moreover, downward arrows indicate the downward hot air 51.

FIG. 2(b) illustrates a state in which the upward hot air 41 is, at the doming step A, pumped to the bonding sheet 20 and the dome-shaped bonding layer 22 is formed accordingly. At this point, the downward hot air 51 is also pumped simultaneously. That is, for molding the dome-shaped bonding layer 22, the upward hot air 41 from below needs to be stronger than the downward hot air 51 from above. For obtaining a favorable dome-shaped bonding layer 22, a pressure difference between the upward hot air and the downward hot air as described above needs to be utilized.

FIG. 2(c) illustrates a state in which the dome-shaped bonding layer 22 molded at the doming step A is ruptured. For such rupturing, the downward hot air 51 is pumped from above to the vicinity of the top 23 of the dome-shaped bonding layer 22. When the downward hot air is pumped, if the downward hot air 51 is pumped to other locations than the vicinity of the top 23, the bonding layer 30 is not equally distributed to each cell 11. Thus, the bonding layer 22 needs to be ruptured by any of a method in which the downward hot air 51 is on the vicinity of the top 23 in a focused manner and a method in which the downward hot air 51 is pumped along a line over the tops 23, as illustrated in FIG. 2(c).

FIG. 2(d) illustrates a state in which the dome-shaped bonding layer 22 is ruptured at the rupturing step B. By such rupturing, the bonding layer 30 is equally dispersed to each rib 12. Such rupturing and dispersion can be also performed only by the upward hot air 41 from below. However, when rupturing is randomly performed only by the upward hot air 41, the uniform bonding layer 30 cannot be obtained. For this reason, for forming the bonding layer 30 in the state illustrated in FIG. 2(d), a relationship between pumping of the upward hot air 41 from below and pumping of the downward hot air 51 from above is important. After study has been conducted on various requirements such as a temperature, a pressure, a position, and the shape of a bottom-side nozzle 62, an optimal state is preferably set.

FIG. 2(e) illustrates a state in which the melted dome-shaped bonding layer 22 is uniformly distributed to the upper side of the rubs 12 by surface tension. Then, the honeycomb core 10 is formed such that an adequate amount of adhesive forms the uniform bonding layer 30 from the upper side of the joined ribs 12 to a wall portion of the cell 11. Upon formation of the bonding layer 30, a temperature, a pressure, a speed, time, etc. are managed such that the honeycomb core 10 having the uniform bonding layer 30 is formed.

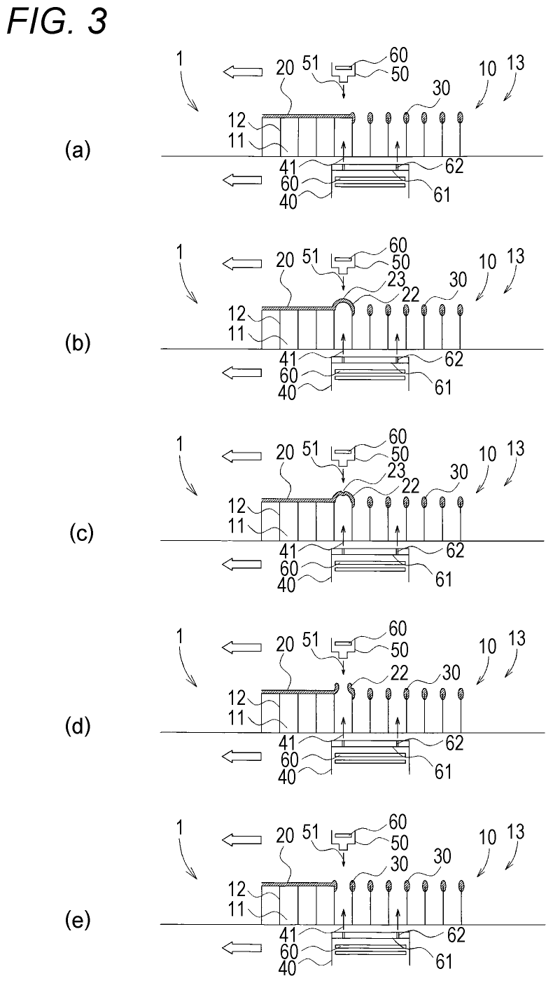

FIG. 3 is a view for describing heating states in the honeycomb core manufacturing method 1 using the domed bonding layer according to the present invention. FIGS. 3(a) to 3(e) each correspond to the heating states of FIGS. 2(a) to 2(e) described above. Moreover, it is configured such that the bottom-side hot air device 40 is arranged in two lines and the bottom-side hot air device 40 and the upper-side hot air device 50 are movable relative to the core 13. Thus, spots in a non-uniform thermal welding state are made uniform to obtain the more uniform bonding layer 30.

Moreover, horizontal thick arrows illustrated in the figure indicate a movement direction of the bottom-side hot air device 40 and the upper-side hot air device 50. From a state in which the bonding sheet 20 is laid on the upper surface of the core 13, the bonding layer 22 is brought into a dome shape by the upward hot air 41 pumped from the bottom-side hot air device 40. Then, the step of forming the uniform bonding layer 30 by meltability and surface tension from the dome-shaped bonding layer 22 ruptured by the downward hot air 51 pumped from the upper-side hot air device 50 is continuously repeated for each line.

The bottom-side hot air device 40 and the upper-side hot air device 50 are movable in the horizontal direction relative to the core 13. Then, each step from the doming step A to the thermal welding step C or from the doming step A to the re-heating step D is repeated. Note that the present invention is not limited to such a configuration. It is also effective for a configuration in which the core 13 moves relative to the bottom-side hot air device 40 and the upper-side hot air device 50.

At the re-heating step D, the bottom-side hot air device 40 is arranged in two lines. Thus, the spots in the non-uniform thermal welding state are uniformized so that the more uniform bonding layer 30 can be obtained. Note that although not shown in the figure, the upper-side hot air device 50 can be also arranged in two lines. Thus, it is effective that it is configured such that the cells 11 which have not been ruptured upon first heating are reliably ruptured by repetition of the same step.

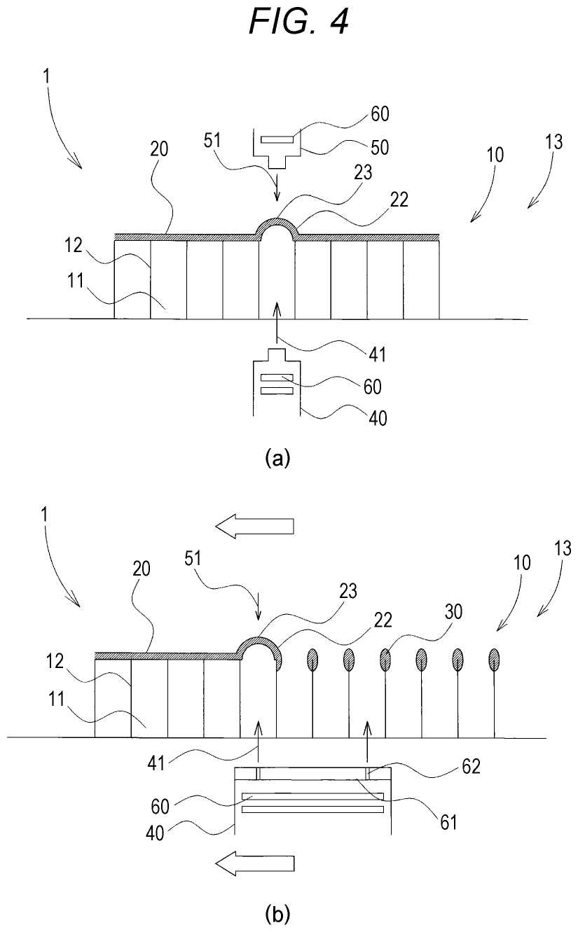

In a honeycomb core manufacturing device 2 using the domed bonding layer according to the present invention, the multiple cells 11 are uniformly bonded and formed. Thus, it is a biggest feature that the dome-shaped bonding layer 22 formed by the upward hot air 41 from the bottom-side hot air device 40 is uniformly ruptured by the downward hot air 51 from the upper-side hot air device 50. Hereinafter, each configuration of the honeycomb core manufacturing device 2 using the domed bonding layer according to the present invention will be described with reference to FIGS. 4 to 8. Note that unless otherwise specified, numerical values and materials used for the honeycomb core manufacturing device 2 using the domed bonding layer according to the present invention are not limited. That is, changes can be made within the scope of the technical idea of the present invention, i.e., the scope of numerical values or materials providing the same features and advantageous effects.

FIG. 4 is a view for describing a hot air pumping state in the honeycomb core manufacturing device 2 using the domed bonding layer according to the present invention. FIG. 4(a) is a plan view of the hot air pumping state for each cell 11 by the bottom-side hot air device 40 and the upper-side hot air device 50. Moreover, FIG. 4(b) is a sectional view of the hot air pumping state for each cell 11 by the bottom-side hot air device 40 and the upper-side hot air device 50.

In the honeycomb core manufacturing device 2 using the domed bonding layer, the thermally-weldable bonding sheet 20 is heated while the bottom-side hot air device 40 and the upper-side hot air device 50 are moving relative to the core 13. Moreover, the honeycomb core manufacturing device 2 is a device configured to manufacture the honeycomb core 10 by thermal welding to the core 13. In this device according to the present invention, a surface accuracy of equal to or higher than that of a honeycomb panel as a general molded article can be obtained. Specifically, in the honeycomb core manufacturing device 2 using the domed bonding layer, the hot air is pumped to the bonding sheet 20 for each cell 11 to soften the bonding sheet 20. Accordingly, thermal welding is performed utilizing a slight difference between time and a pressure. That is, long-term heating or pressurization is not necessary. Thus, all processes are sequentially performed for each cell 11. As a result, it is configured such that influence of heat on the core 13 and influence of stress can be significantly reduced.

The honeycomb core 10 generally indicates a structure in which hexagons such as a honeycomb or other three-dimensional shapes (the cells 11) are arranged without clearances. As compared to a general plate-shaped member, the honeycomb core 10 has such a feature that the honeycomb core 10 is lightweight and has high strength. In addition, a structure learnt from nature has many excellent properties such as a large surface area, high impact absorption, and rectification action or thermal insulation performance. The honeycomb core 10 obtained from the honeycomb core manufacturing device 2 using the domed bonding layer according to the present invention has high accuracy. Moreover, the honeycomb core 10 can be an assembly of the cells 11 using various materials such as paper, aluminum, and plastic.

The cell 11 indicates one clearance region of a structure in which the same solids are arranged without clearances. Moreover, the section of the cell 11 may be a representative hexagon or other shapes such as a circle and a polygon. Note that at the doming step A in the present invention, the hot air needs to be pumped to at least one cell 11 once. Since the cell 11 itself is the clearance region, the shape of the cell 11 is set by the ribs 12 connecting each solid.

The rib 12 is a wall portion sharing, with an adjacent call 11, one surface or one side of the same three-dimensional shape forming the cell 11.

The core 13 is a structure in which the multiple cells 11 formed by the ribs 12 are assembled. Moreover, the core 13 indicates a state before bonding of the cells 11.

The bonding sheet 20 is a resin sheet to be melted by heating. The bonding sheet 20 has a lower melting point than the material of the core 13. Moreover, one having melting properties within a short period of time is used as the bonding sheet 20. For example, various bonding sheets 20 such as polyimide-based resin, phenol-based resin, epoxy-based resin, acrylic-based (polymethyl methacrylate (PMMA)) resin, vinyl chloride, and silicone-based resin are present. Easily-meltable materials having a low melting point and having high strength after thermal welding are preferably selected as these materials. For example, in a case where the core 13 is aluminum, the bonding sheet 20 such as the phenol-based resin or the epoxy-based resin is preferable. Moreover, in a case where the core 13 is a material such as titanium or stainless steel and requires thermal resistance, the bonding sheet 20 made of the silicone-based resin is used. As described above, the bonding sheet 20 is preferably selected depending on the intended use.

The dome-shaped bonding layer 22 is a bulge formed after softening of the bonding sheet 20 by the upward hot air 41 pumped from the bottom-side hot air device 40. Such a bulge can be formed in such a manner that the bonding sheet 20 is equally deformed from the substantially center to protrude upward from an edge portion of the cell 11.

The top 23 is an uppermost portion of a protrusion from the dome-shaped bonding layer 22, the protrusion being obtained by the upward hot air 41 pumped from the bottom-side hot air device 40. Moreover, the vicinity of the top 23 is a portion to be initially ruptured by contact of the downward hot air 51 pumped from the upper-side hot air device 50.

The bonding layer 30 is an adhesive layer connecting the edge portions of the multiple cells 11 by heating of the bonding sheet 20. This layer needs to be such an amount that the bonding layer 30 can be evenly and equally applied to the edge portion of each cell 11. Moreover, sufficient binding force needs to be obtained among the cells. Further, in the present invention, the bonding layer 30 is applied only to an upper edge portion of each cell 11. Thus, flexibility can be provided to each cell. Note that FIG. 4 illustrates the bonding layer 30 only on an upper surface of the honeycomb core 10. On the other hand, a configuration in which the bonding layer 30 is similarly applied to an opposite surface with the core 13 being inverted and the cells 11 are connected accordingly can be employed. In this case, the honeycomb core 10 with higher strength can be obtained.

Moreover, the bonding layer 30 is bonded to the edge portion of each cell 11 with the bonding layer 30 being raised by surface tension. In a typical bonding method, there are problems that the adhesive is not equally dispersed only to the edge portions of the cells 11, such as hanging of the bonding sheet 20 down from a wall surface of the rib 12. For this reason, there is a problem that a useless portion not contributing to the binding force of the adhesive is caused at the edge portion. The present invention solves this problem, and exhibits an effect of more reducing an adhesive amount and contributing to weight reduction.

The bottom-side hot air device 40 is a device configured to pump the hot air from a bottom portion of the core 13 to heat the bonding sheet 20 laid on the upper surfaces of the cells 11. The bottom-side hot air device 40 needs a temperature for melting the bonding sheet 20 and a pressure and a blown air volume necessary for expanding the bonding sheet 20 in the dome shape. Specifically, the bottom-side hot air device 40 needs to equally pump the upward hot air 41 to each cell 11 arranged in the core 13. Such uniformization is preferably performed through a rectifier plate 60 configured to rectify the upward hot air 41 due to heating.

The upward hot air 41 is high-heat gas to be pumped by the bottom-side hot air device 40 for forming the dome-shaped bonding layer 22. The upward hot air 41 is sent toward the substantially center of each cell 11.

The upper-side hot air device 50 is a device configured to rupture the dome-shaped bonding layer 22 on each cell 11, the dome-shaped bonding layer 22 being formed by the upward hot air 41 from the bottom-side hot air device 40. The hot air is pumped to push the softened dome-shaped bonding layer 22 from above to below the bonding layer 22. Accordingly, the bonding layer 22 becomes easily rupturable. Further, an air flow is pushed back such that the bonding layer 30 is easily and equally formed on the edge portions of the cells 11 by means of surface tension. Note that it is effective to employ a configuration in which a nozzle shape for spraying, in a slit shape, the hot air pumped from the upper-side hot air device 50 is employed to more easily rupture the bonding layer 22.

The downward hot air 51 is high-temperature gas for rupturing the dome-shaped bonding layer 22 formed by the upward hot air 41. The downward hot air 51 is pumped to a position in the vicinity of the top 23 of the dome-shaped bonding layer 22, or is pumped in parallel with a line connecting the tops 23 of the cells 11 adjacent to each other. The downward hot air 51 is pumped with a lower pressure than that for the upward hot air 41.

Note that the upward hot air 41 and the downward hot air 51 are gas heated as compressed air and sent in a pressurization state by, e.g., a blower or a fan. Alternatively, the upward hot air 41 and the downward hot air 51 may be obtained in such a manner that air pressurized using an air compression device such as an air compressor is heated by, e.g., a sheath heater.

Further, according to the honeycomb core manufacturing method 1 using the domed bonding layer according to the present invention, a heating unit using gas as the hot air is employed for heating for each cell 11, and such heating is completed by heating for a short period of time. Thus, the effect of reducing influence of heat on the core 13 is exhibited.

The rectifier plate 60 is used as a rectifier configured to supply, in the state of pumping the upward hot air 41 and the downward hot air 51, equally-rectified heated air to a nozzle plate 61. Although schematically illustrated in the figure, it is assumed that one configured such that many honeycomb members or net-shaped filters are stacked on each other is used. In the case of using the honeycomb members for the rectifier plate 60, a regular polygon close to a circle is preferably used. Moreover, although not shown in the figure, a contraction flow body is preferably provided at, e.g., the fan as a blown air source for avoiding a non-uniform air flow due to a propeller.

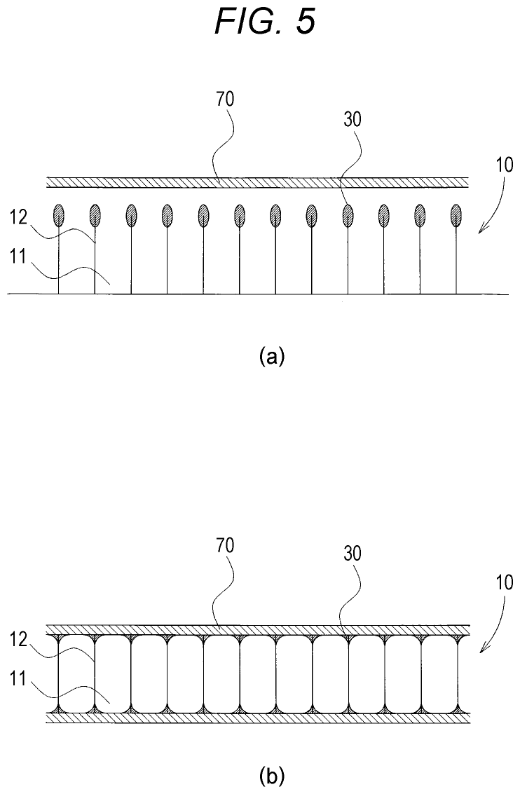

FIG. 5 is a view for describing an embodiment in which the face plate 70 is bonded to the honeycomb core 10 according to the present invention. FIG. 5(a) illustrates the state of the bonding layer 30 for bonding the face plate 70 to the honeycomb core 10. FIG. 5(b) illustrates a configuration in which the face plates 70 bonded to the honeycomb core 10 are provided on both surfaces.

The normal honeycomb panel often uses a configuration including the face plates 70 on both surfaces. The material of the face plate 70 directly influences stiffness of the honeycomb panel. Thus, the material is selected as necessary depending on the intended use. Various materials such as aluminum, titanium, stainless steel, iron, paper, and resin are applicable. Moreover, depending on the strength of the face plate 70, a deflection amount is greatly influenced. Thus, the size of the cell 11 is also considered.

As illustrated in FIG. 5(a), the face plate 70 and the honeycomb core 10 are bonded in a state in which the bonding layer 30 is raised by surface tension on the upper and lower edge portions of each cell 11. Thus, the bonding layer 30 can be utilized as an adhesive for the face plate 70. Thus, an adhesive does not need to be applied again.

Note that as illustrated in FIG. 5(a), the honeycomb core 10 can be curved with a curved surface in a state in which the bonding layer 30 is formed only on one surface of the honeycomb core 10. When the face plate 70 is bonded in such a curved state, the curved honeycomb panel can be easily formed.

Moreover, FIG. 5(b) illustrates a configuration in which the face plates 70 are bonded to both surfaces of the honeycomb core 10. Such a configuration uses the honeycomb core 10 obtained in such a manner that the honeycomb core manufacturing method 1 using the domed bonding layer according to the present invention is performed for both surfaces. Note that in the case of bonding the face plates 70 to both surfaces, the core 13 needs to be inverted after one side has been processed at an initial step. Thus, a non-adhesive material such as a silicone sheet or a Teflon (registered trademark) sheet is preferably bonded to a fixing tool for fixing the core 13. Alternatively, the fixing tool made of the non-adhesive material is preferably used to enhance detachability.

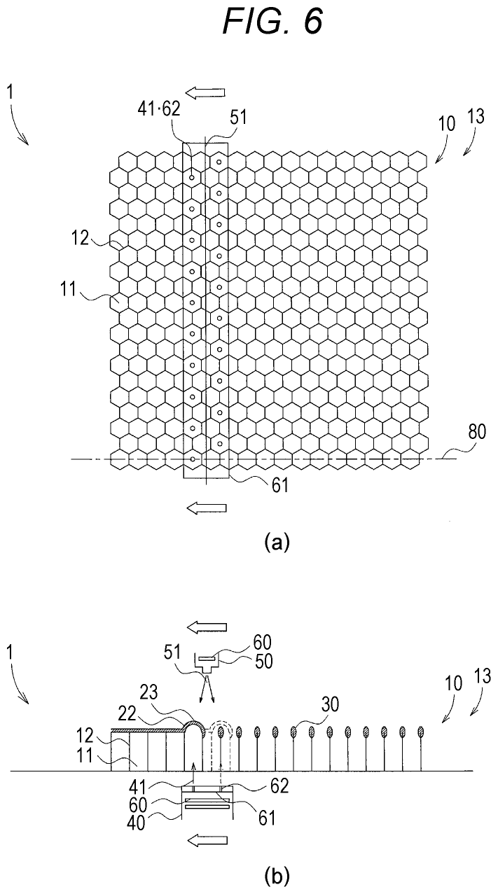

FIG. 6 is a view for describing an arrangement state regarding the hot air to be pumped to each cell 11 in the honeycomb core manufacturing device 2 using the domed bonding layer according to the present invention. FIG. 6(a) is a plan view of arrangement relative to each cell 11 regarding the hot air from each of the bottom-side hot air device 40 and the upper-side hot air device 50. Moreover, FIG. 6(b) is a sectional view of the state of blowing the hot air from each of the bottom-side hot air device 40 and the upper-side hot air device 50 to each cell 11.

As illustrated in FIG. 6(a), the bottom-side hot air device 40 and the corresponding upper-side hot air device 50 have the bottom-side nozzles 62 for pumping the hot air. A configuration in which the bottom-side nozzles 62 are arranged to pump the hot air to the substantially centers of the cells 11 adjacent to each other in a linear shape through the ribs 12 is employed. Such a configuration is employed because the bonding layer 30 is distributed to the upper side of the adjacent cells 11 when the above-described configuration is not employed and the rib 12 on one side is shared and it is, as a result, difficult to equally form the dome-shaped bonding layer 22 on each cell 11 at the doming step A.

Moreover, the positions of upper-side nozzles 63 provided at the upper-side hot air device 50 configured to pump the downward hot air 51 are at the substantially center between two lines in which the bottom-side nozzles 62 arranged on the nozzle plate 61 connect the cells 11 adjacent to each other in the linear shape through the ribs 12. The upper-side nozzles 63 move while linearly pumping the downward hot air 51 to the core 13. Thus, the downward hot air 51 acts on a weak portion caused at the substantially center of the dome-shaped bonding layer 22. Then, the dome-shaped bonding layer 22 is partially ruptured. In this manner, the substantially-uniform bonding layer 30 is formed on the ribs 12 by surface tension and blowing of the upward hot air 41.

The nozzle plate 61 is a plate-shaped member provided with holes or the bottom-side nozzles 62 for spraying, to predetermined cells 11, the upward hot air 41 rectified by the rectifier plate 60. As illustrated in FIG. 6(b), such a nozzle plate 61 is provided at the bottom-side hot air device 40. Moreover, the nozzle plate 61 serves as a base of the holes or the bottom-side nozzles 62 for spraying the upward hot air 41 to the substantially centers of the cells 11. For separating the cells 11 to which the upward hot air 41 is to be pumped and the cells 11 to which the upward hot air 41 is not to be pumped, the holes or the bottom-side nozzles 62 are, as illustrated in FIGS. 6 to 8, provided for every predetermined line connecting predetermined cells 11 at pitches equal to pitches corresponding to an interval between the cells 11. Note that the nozzle plate 61 is replaceable depending on, e.g., the size of the cell 11 of the core 13.

The bottom-side nozzle 62 is a spray port for spraying the rectified hot air to each cell 11, and is formed by the hole provided at the nozzle plate 61. Note that the bottom-side nozzle 62 is not necessarily the nozzle hole illustrated in FIG. 6, and may be a spray nozzle configured such that a nozzle pipe for specifying a hot air flow direction protrudes as illustrated in FIG. 2.

A laser 80 is used for positioning for placing the core 13 at the honeycomb core manufacturing device 2 using the domed bonding layer according to the present invention. The laser 80 serves as a mark for arranging the core 13 such that the positions of the upper-side nozzles 63 of the bottom-side hot air device 40 and the upper-side hot air device 50 are at the center of the cell 11. For adjusting the position of the laser 80 and the position of the center of the cell 11, the fixing tool for the core 13 may be moved and visually adjusted. However, the control function of capturing the center of the cell 11 by image processing to automatically move and adjust the fixing tool for the core 13 to the center is preferably provided.

Note that when the core 13 is large, deflection of the fixing tool occurs. For this reason, a reinforcement member such as a wire or a wire rod is preferably used. This can lead to a configuration in which deflection is reduced.

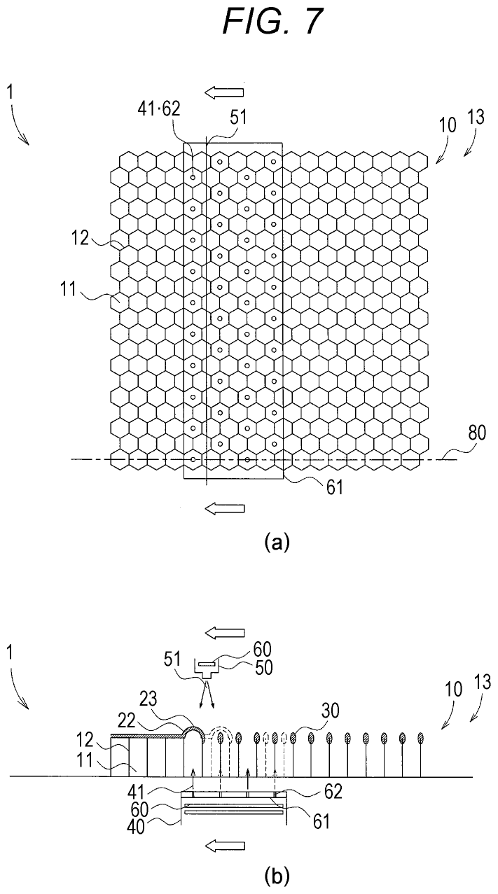

FIG. 7 is a view for describing a configuration in which the bonding layer 30 is re-heated in the honeycomb core manufacturing device 2 using the domed bonding layer according to the present invention. FIG. 7(a) is a plan view of arrangement of the bottom-side nozzles 62 of the nozzle plate 61. Moreover, FIG. 7(b) is a sectional view of arrangement of the bottom-side nozzles 62 of the nozzle plate 61.

The configuration of the manufacturing device illustrated in FIG. 7 includes the re-heating step D employing a configuration in which the cells 11 heated once are re-heated by heating with the bottom-side nozzles 62. The same cells 11 are re-heated to smooth the bonding layer 30 welded once. Thus, the more uniform bonding layer 30 can be formed. Note that such a configuration is for smoothing the bonding layer 30, and is not for rupturing. Thus, the bottom-side nozzles 62 for heating at two stages are arranged, and on the other hand, it is enough to arrange the upper-side nozzles 63 in a single line.

Note that in the honeycomb core manufacturing method 1 using the domed bonding layer and the honeycomb core manufacturing device 2 using the domed bonding layer according to the present invention, a doming state and a rupturing state vary depending on a temperature, a pressure, a speed, and the material of the bonding sheet 20. Thus, for bringing a more proper state, e.g., experiment is preferably repeatedly performed. This can find proper conditions, and these conditions can be set in, e.g., a program to perform automatic control.

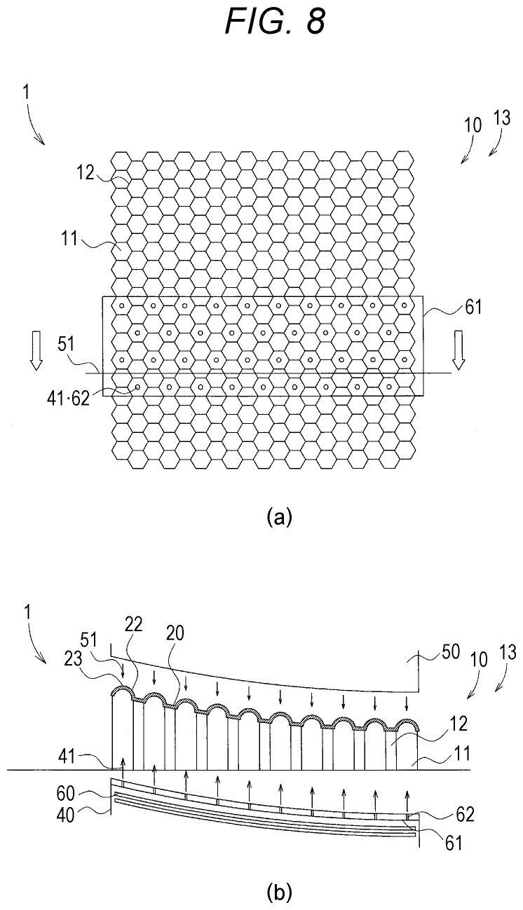

FIG. 8 is a view for describing the method for processing the curved surface in the honeycomb core manufacturing device 2 using the domed bonding layer according to the present invention. FIG. 8(a) is a plan view of the state of blowing the hot air from each of the bottom-side hot air device 40 and the upper-side hot air device 50 to each cell 11. FIG. 8(b) is a sectional view of the state of blowing the hot air from the bottom-side hot air device 40 and the upper-side hot air device 50 to each cell 11.

The honeycomb core 10 has such a feature that the strength is significantly high as described above, and on the other hand, there is a problem that it is basically difficult to use the honeycomb core 10 in a curved shape or a curved state. However, according to the honeycomb core manufacturing device 2 using the domed bonding layer according to the present invention, the positions of the bottom-side nozzles 62 configured to pump the upward hot air 41 from the bottom-side hot air device 40 and a distance to the bonding sheet 20 arranged on each cell 11 are, as illustrated in FIG. 8, adjusted so that the honeycomb core 10 having the curved surface can be easily manufactured.

Unlike the illustrated configuration, the position of the bottom-side hot air device 40 may be in parallel with the core 13, and any of the bottom-side hot air device 40 and the core 13 may be arranged horizontally. Alternatively, a height may be differentiated among the cells 11 to adjust the temperature or pressure of the upward hot air 41 pumped from the bottom-side hot air device 40. With this configuration, the uniform dome-shaped bonding layer 22 can be formed on each cell 11 of the core 13 having a curved surface.

Note that the illustrated bottom-side hot air device 40 has the following configuration. In this configuration, the bottom-side nozzles 62 for pumping the hot air is arranged such that the hot air is pumped to the substantially centers of the cells 11 adjacent to each other in the linear shape through the ribs 12. With this configuration, the pitch between the bottom-side nozzles 62 is changed so that bonding molding by thermal welding can be performed even for the core 13 arranged at the same pitch or different pitches.

### INDUSTRIAL APPLICABILITY

The present invention does not necessarily use a large device such as an autoclave. Moreover, even an elongated honeycomb core can be manufactured. The cost can also be reduced. Thus, use applications of the honeycomb core can be expanded, and industrial applicability is high.

### DESCRIPTION OF REFERENCE SIGNS

1 Honeycomb core manufacturing method using domed bonding layer
2 Honeycomb core manufacturing device using domed bonding layer
10 Honeycomb core
11 Cell
12 Rib
13 Core
20 Bonding sheet
22 Dome-shaped bonding layer
23 Top
30 Bonding layer
40 Bottom-side hot air device
41 Upward hot air
50 Upper-side hot air device
51 Downward hot air
60 Rectifier plate
61 Nozzle plate
62 Bottom-side nozzle
63 Upper-side nozzle
70 Face plate
80 Laser
A Doming step
B Rupturing step
C Thermal welding step
D Re-heating step

1. A method (1) for manufacturing a honeycomb core (10) by a domed bonding layer, comprising:
a doming step (A) of pumping, when bonding molding is performed for a core (13) including multiple connected ribs (12) forming an assembly of cells (11) by means of a flat thermally-weldable bonding sheet (20) laid on an upper surface of the core (13), upward hot air (41) upwardly into the cells (11) to form a dome-shaped bonding layer (22) at the bonding sheet (20) on an upper surface of each cell (11);
a rupturing step (B) of pumping downward hot air (51) from above to a vicinity of a top (23) of the dome-shaped bonding layer (22) to rupture the bonding layer; and
a thermal welding step (C) of forming a uniform bonding layer (30) on upper edge portions of the cells (11) by means of meltability and surface tension of the bonding sheet (20).

2. The method (1) for manufacturing the honeycomb core by the domed bonding layer according to claim 1, further comprising a re-heating step (D) of re-heating the bonding layer after the doming step (A) to the thermal welding step (C).

3. The method (1) for manufacturing the honeycomb core by the domed bonding layer according to claim 1, wherein;
the upward hot air (41) is toward substantially centers of the cells (11), and the downward hot air (51) is in parallel with a line passing through the top (23).

4. The method (1) for manufacturing the honeycomb core by the domed bonding layer according to claim 1, wherein;
at the doming step, the upward hot air (41) to be pumped is adjusted according to heights of the cells (11) to form the dome-shaped bonding layer (22) and provide a curved surface to the honeycomb core (10).

5. A device for manufacturing a honeycomb core (10) by a domed bonding layer, comprising:
a bottom-side hot air device (40) configured to pump, when bonding molding is performed for a core (13) including multiple connected ribs (12) forming an assembly of cells (11) by means of a flat thermally-weldable bonding sheet (20) laid on an upper surface of the core (13), upward hot air (41) into the cells (11) upwardly through a nozzle plate (61) to form a dome-shaped bonding layer (22) at the bonding sheet (20) on an upper surface of each cell (11); and
an upper-side hot air device (50) configured to pump downward hot air (51) from above to a vicinity of a top (23) of the dome-shaped bonding layer (22) to rupture the bonding layer, wherein;
a uniform bonding layer (30) is formed on upper edge portions of the cells (11) by means of meltability and surface tension of the bonding sheet (20).

6. The device (2) for manufacturing the honeycomb core by the domed bonding layer according to claim 5, wherein
bottom-side nozzles (62) provided at the nozzle plate (61) are arranged in two or more lines to re-heat the bonding layer (30).

7. The device (2) for manufacturing the honeycomb core by the domed bonding layer according to claim 5, wherein
the upward hot air (41) is toward substantially centers of the cells (11), and the downward hot air (51) is in parallel with a line passing through the top (23).

8. The device (2) for manufacturing the honeycomb core by the domed bonding layer according to claim 5, wherein
the upward hot air (41) to be pumped to the bonding sheet (20) by the bottom-side hot air device (40) is adjusted according to heights of the cells (11).
